(19) United States
(12) Patent Application Publication
(10) Pub. No.: US 2006/0236361 A1
(43) Pub. Date: Oct. 19, 2006

(54) Storing repetition information for dsmcc carousel

(76) Inventors: Declan Patrick Kelly, Eindhoven (NL); Philip Steven Newton, Eindhoven (NL); Richard James Houldsworth, Redhill (GB)

Correspondence Address: PHILIPS INTELLECTUAL PROPERTY & STANDARDS, P.O. BOX 3001, BRIARCLIFF MANOR, NY, 10510, US

(21) Appl. No.: 10/548,706

(22) PCT Filed: Dec. 18, 2003
(86) PCT No.: PCT/IB03/06112

§ 371 Date: Sep. 8, 2005

(30) Foreign Application Priority Data
Jan. 28, 2003 (EP) 03250517.4

(51) Int. Cl. H04N 7/16

(52) U.S. Cl. 725/135

(57) ABSTRACT

A method (6,7) and device (8) for recording and/or reproducing interactive television data via a digital interface (45), wherein said data is transmit inside modules through a DSMCC data/object carousel (2) with a first bandwidth. The method comprises the steps of calculating repetition rates of said modules in said DSMCC carousel (2), recording said modules, together with said repetition rates of said modules, from said digital interface (45) to a storage medium of a recording device, and/or playing back said data inside modules through a second DSMCC Data/Object Carousel (4) over said digital interface (45) and from a storage medium, preferably using the complete available bandwidth of said digital interface for said DSMCC Data/Object Carousel (4), wherein said modules are preferably re-inserted over the digital interface (45), such as into a Transport Stream, at a repetition rate being stored together with said modules on said storage medium.

### FIELD OF THE INVENTION

This invention relates in general to the field of interactive television and more particularly to the recording of interactive television content or other streams with audio-visual data and application data and even more particularly to restoring of an interactive television data stream via a digital interface.

### BACKGROUND OF THE INVENTION

Interactive television (iTV) is becoming more and more popular. An example of interactive television is the Multimedia Home Platform (MHP), which is a digital video broadcasting (DVB) standard intended to combine digital television (DTV) with interactivity and access to the Internet and the World Wide Web. DTV service providers offer a large variety of audio-visual (AN) television programs and also of applications that allow the interaction of the viewer/user with the TV set and its contents.

Interactive television content, such as MHP, transmits applications in a Transport Stream (TS) inside modules through a Digital Storage Media Command and Control (DSMCC) object carousel. The DSMCC-Modules are transmitted in the same TS as the Audio/video content. The DSMCC data/object carousel defines how and when to send modules/files containing applications in the TS together with the audio-visual content down a broadcast channel. There is no connection to the server for a receiving device to ask for wanted files. All files are repeatedly sent all the time, e.g. once every 10 seconds. Interactive television terminals, e.g. MHP terminals, such as a Set Top Box (STB), look for the files they need as they come around.

In a broadcast Transport Stream, the modules are repeated but different modules may be repeated with different frequencies. The choice of the repetition rates and the module order in the broadcast can be based on knowledge of how the modules are used and therefore the repetition rates and module order are optimised for the specific application being broadcast.

Similar to today's video recorders for analogue television broadcasts using video tapes for recording broadcast streams, digital video recorders for interactive television are developed using either a harddisk or removable media such as optical discs for storing recorded broadcasts. The digital video recorders for interactive television record both A/V television contents and applications for playback at a later point in time.

When recording interactive television, iTV modules/files are extracted from the Transport Stream. These modules are generally stored outside the Transport Stream in a separate file. In some cases the stored modules are re-inserted into the Transport Stream for playback over a digital interface to an external STB with an MHP stack.

When the stored modules are re-inserted back into a Transport Stream it is not possible to optimise the rates of the modules because the use of the files within the modules is not known. This might lead to a reconstructed Transport Stream, of which the iTV application cannot be executed properly by e.g. a STB, because e.g. the CPU of the STB is overloaded.

### SUMMARY OF THE INVENTION

The present invention overcomes the above-identified deficiencies and solves the above problems by providing a method, device and computer readable medium according to the appended independent claims.

The general solution according to the invention is as follows. When playing back the DSMCC Data/Object Carousel over a digital interface, such as in a Transport Stream, the performance is improved with respect to the original broadcast by using the complete bandwidth available for a DSMCC Data/Object Carousel. Using the extra bandwidth available allows modules to be repeated more often than in the original and therefore the performance of the interactive application with regards to the time to load the application can be improved over the original broadcast.

More particularly, the modules are re-inserted into a DSMCC carousel in an optimum way. More specifically modules carrying much-used files are repeated more often. When recording the DSMCC modules the relative repetition rates of the modules are calculated. The repetition rates are stored together with the modules. The stored repetition rates related to the modules are used when regenerating the Transport Stream from the recorded modules. When re-multiplexing the Transport Stream, the modules are preferably inserted into the Transport Stream with the same relative frequency. The relative priorities of the modules is stored with the modules, in the case of MHP, preferably in an extra information and configuration file which we will refer to as the MHP Info file. Preferably the relative priorities of the modules are stored on the same storage medium as the modules.

### BRIEF DESCRIPTION OF THE DRAWINGS

Preferred embodiments of the present invention will be described in the following detailed disclosure, reference being made to the accompanying drawings, in which

FIG. 1 shows a schematic overview over an iTV recording system in recording mode,

FIG. 2 is a schematic overview over an iTV recording system in playback mode,

FIG. 3 illustrates in a flowchart an embodiment of a method according to the invention,

FIG. 4 is a flowchart of another embodiment of a method according to the invention,

FIG. 5 is a schematic diagram showing an embodiment of the device according to the invention, and

FIG. 6 shows the computer readable medium according to the invention.

### DESCRIPTION OF PREFERRED EMBODIMENTS

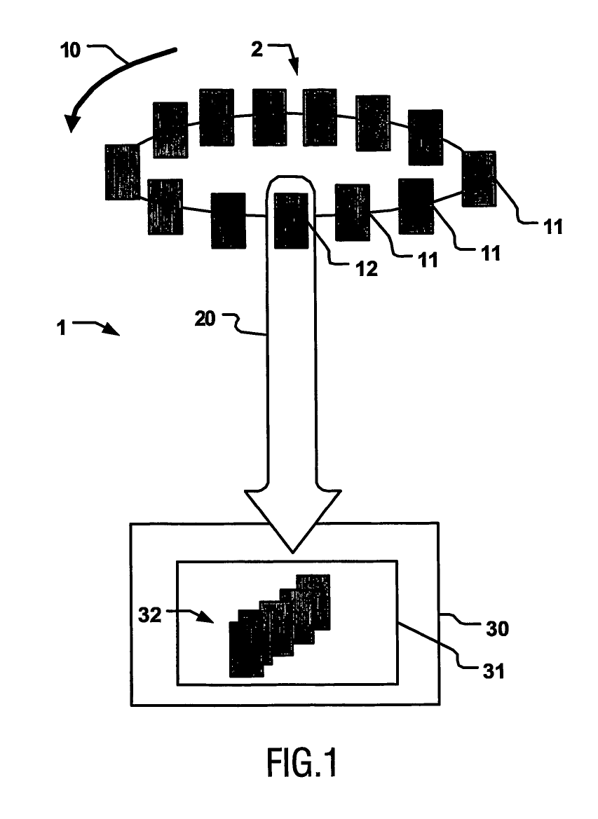

FIG. 1 shows a schematic overview over an iTV recording system 1 in recording mode. Interactive television content or other streams with audio-visual data and application data, such as MHP, transmits applications in a Transport Stream (TS) inside modules through a Digital Storage Media Command and Control (DSMCC) object carousel. Audio-visual content is transmitted in the same TS inside modules through a DSMCC data carousel. Interactive television content, such as MHP, transmits applications in a Transport Stream (TS) inside modules through a Digital Storage Media Command and Control (DSMCC) object carousel. Audio-visual content is transmitted in the same TS inside modules through a DSMCC data carousel. Interactive television content, such as MHP, transmits applications in a Transport Stream (TS) inside modules through a Digital Storage Media Command and Control (DSMCC) object carousel. Interactive television content, such as MHP, transmits applications in a Transport Stream (TS) inside modules through a Digital Storage Media Command and Control (DSMCC) object carousel. Interactive television content, such as MHP, transmits applications in a Transport Stream (TS) inside modules through a Digital Storage Media Command and Control (DSMCC) object carousel. Interactive television content, such as MHP, transmits applications in a Transport Stream (TS) inside modules through a Digital Storage Media Command and Control (DSMCC) object carousel. Audio-visual content is transmitted in the same TS.

Interactive television content, such as MHP, is transmitted over a digital interface 20, such as in a Transport Stream (TS), inside modules 12 through a Digital Storage Media Command and Control (DSMCC) object carousel 2. Audio-visual content is transmitted in the same TS 20. Arrow 10 indicates the rotation of objects 11 in the carousel over time. The TS 20 is received by a recording device, such as an MHP video recorder. Recording device 30 comprises a storage medium 31 on which files/objects 32 are recorded from the TS.

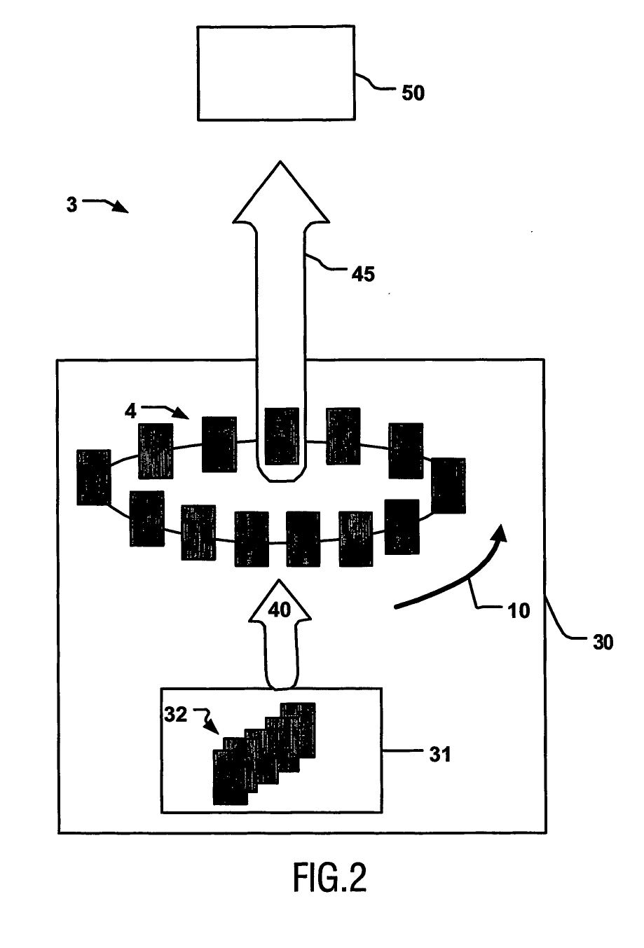

FIG. 2 is a schematic overview over an iTV recording system 3 in playback mode. Files/modules 32 from the recorded interactive television content, are transferred from storage medium 31, to a DSMCC object carousel 4. As shown in FIG. 2, the files/modules and audio-visual content are broadcast via a digital interface 45, such as in a Transport Stream (TS), inside modules through the DSMCC object carousel 4. Arrow 10 indicates the rotation of objects 11 in the carousel over time. The TS 45 is received by a receiving device 50, such as a Set Top Box (STB).

When playing back the DSMCC Data/Object Carousel over a digital interface, such as in a Transport Stream, the performance is improved with respect to the original broadcast, preferably by using the complete bandwidth available for a DSMCC Data/Object Carousel. This is e.g. for SI data equal to 1 Mbps and limited by the bitrate allowed in an MPEG-2 Transport Stream for SI data. The actual number of repetitions is preferably increased, compared to the original repetition rate, as a higher bandwidth is available. This is due to the fact that a digital interface can generally accommodate more bandwidth than a broadcast link. Using the extra bandwidth available allows modules to be repeated more often than in the original and therefore the performance can be improved over the original broadcast.

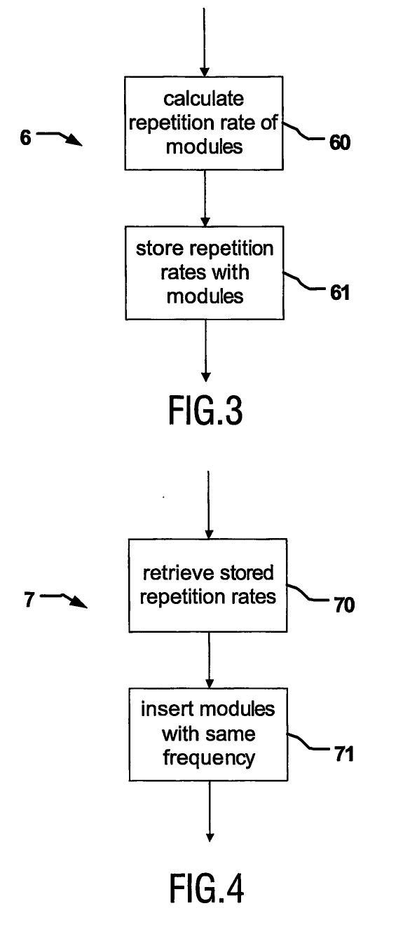

To ensure that the modules are re-inserted into the DSMCC carousel in an optimum way, when recording the DSMCC modules, according to an embodiment of the invention, the relative repetition rates of the modules are calculated in step 60 of a method 6, as shown in FIG. 3. The repetition rates are stored together with the modules in step 61. During recording of the broadcast, preferably the number of repetitions of each module is counted during the time the module is repeated, wherein preferably changes in the module's versions are ignored. The relative size of these values gives the relative priority of each recorded module. The relative priorities of the modules is stored with the modules, in the case of MHP, preferably in the MHP Info file. Preferably the relative priorities of the modules are stored on the same storage medium as the modules.

The stored repetition rates related to the modules are used when regenerating the Transport Stream from the recorded modules in another embodiment of the invention, according to FIG. 4. This ensures the same relative priority for the modules as in the original broadcast. When re-multiplexing the Transport Stream, the modules are preferably re-inserted into a Transport Stream with the same relative frequency. In step 70 of method 7, the stored repetition rates of modules are retrieved and in step 71, the modules are inserted with the same frequency as in the original broadcast, based on the values of the stored repetition rates.

In another embodiment, it is assumed that the repetition rate of the modules might change during the course of a broadcast. Therefore, the repetition rate is stored for each segment of the broadcast to reflect changes in the repetition rates.

According to another embodiment of the invention, the order in which the modules are broadcast is re-generated when re-multiplexing the Transport Stream. In this way the reconstructed Transport Stream is also optimised concerning to the dependencies between the modules. The order in which the modules are re-inserted into the regenerated TS is the same as the order of the modules in the original TS. The order is preferably stored explicitly on the iTV storage medium, e.g. in the MHP Info file. Alternatively this information is comprised implicitly by the order the modules are stored on the iTV storage medium, e.g. in the MHP Modules file.

As well as the actual module data, the Transport Stream contains:
Download Service Initiative (DSI) and
Download Info Indication (DII) messages.

These are also repeated in the stream and thus recorded according to the above description. Increasing the repetition of these messages in the stream may result in an overload of the CPU of the receiving STB. Because the size of these messages is small, they do not take up much bandwidth in the broadcast, in contrast to the modules. Therefore the repetition rate in the broadcast can be expected to be optimum. For these messages the repetition rate of the original is preferably maintained. This is preferably done by counting the number of repetitions in the original and from that calculating the repetition frequency.

MHP uses DSMCC Object Carousel to transport the MHP content in the Transport Stream. The solution according to the invention is not specific for MHP but also works for other iTV content broadcast in a DSMCC Object Carousel or a DSMCC Data Carousel.

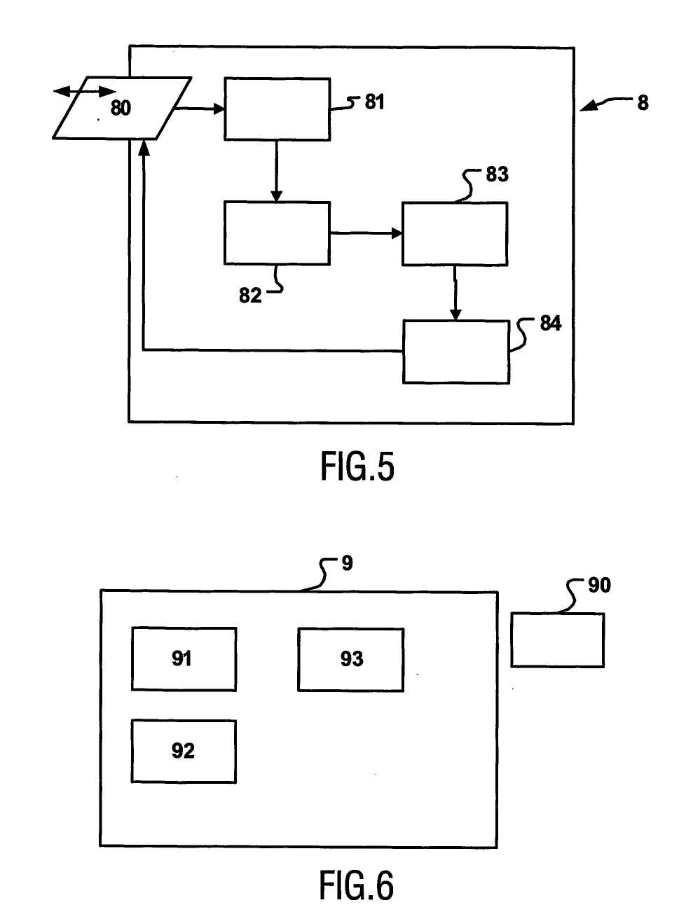

According to another embodiment of the invention, an apparatus 8 for recording and/or reproducing interactive television data via a digital interface 80 is shown in FIG. 5, wherein said data is transmitted inside modules through a DSMCC data/object carousel with a first bandwidth. Device 8 comprises a processing unit for calculating repetition rates of said modules in said DSMCC carousel, a storage device 82 for recording said modules, together with said repetition rates of said modules, from said digital interface to a storage medium 83 of said device. The data is played back with a playback device 84 for playing back said data inside modules through a DSMCC Data/Object Carousel over said digital interface and from said storage medium 83. The modules are preferably re-inserted back in the Transport Stream at a repetition rate being stored together with said modules on said storage medium.

According to another aspect of the invention, a computer-readable medium 9 having embodied thereon a computer program for processing by a computer 90 is provided according to FIG. 6. Interactive television data is recorded and/or streamed via a digital interface, wherein said data is transmitted inside modules through a DSMCC data/object carousel with a first bandwidth. The computer program comprises a first code segment 91 for calculating repetition rates of said modules in said DSMCC carousel. A second code segment 92 is comprised in the computer program for recording said modules, together with said repetition rates of said modules, from said digital interface to a storage medium of a recording device. Alternatively, in case modules are already stored on said storage medium, a third code 93 segment re-inserts said data inside modules through a DSMCC Data/Object Carousel over said digital interface and from said storage medium. The modules are preferably re-inserted back into the Transport Stream at a repetition rate being stored together with said modules on said storage medium.

The present invention has been described above with reference to specific embodiments. However, other embodiments than the preferred above are equally possible within the scope of the appended claims, e.g. different field patterns than those described above, performing the above method by hardware or software, etc.

Furthermore, the term “comprising” does not exclude other elements or steps, the terms “a” and “an” do not exclude a plurality and a single processor or other unit may fulfil the functions of several of the units or circuits recited in the claims.

In summary, the invention relates to method (6,7) and device (8) for recording and/or reproducing interactive television data via a digital interface (45), wherein said data is transmit inside modules through a DSMCC data/object carousel (2) with a first bandwidth. The method comprises the steps of calculating repetition rates of said modules in said DSMCC carousel (2), recording said modules, together with said repetition rates of said modules, from said digital interface (45) to a storage medium of a recording device, and/or playing back said data inside modules through a second DSMCC Data/Object Carousel (4) over said digital interface (45) and from a storage medium, preferably using the complete available bandwidth of said digital interface for said DSMCC Data/Object Carousel (4), wherein said modules are preferably re-inserted over the digital interface (45), such as into a Transport Stream, at a repetition rate being stored together with said modules on said storage medium.

1. A method (6,7) of recording a stream of audio-visual data and application data, via a digital interface (45), wherein said application data is transmitted in modules through a first carousel (2) with a first bandwidth, comprising the steps of:
(a) calculating repetition rates (60) of said modules in said carousel; and
(b) recording said modules (61), together with said repetition rates of said modules, from said digital interface to a storage medium of a recording device.

2. A method according to claim 1, wherein said digital interface (45) is a Transport Stream (TS).

3. A method according to claim 1, wherein said repetition rate is calculated by counting a number of repetitions of each module during the time the module is repeated.

4. A method according to claim 1, wherein said repetition rate is stored for each segment of the stream.

5. A method according to claim 1, wherein the order of said modules is stored on the storage medium.

6. A method according to claim 5, wherein said order of said modules is stored in a file on said storage medium or the order of said modules is comprised in a file structure of said modules on said storage medium.

7. A method according to claim 1, wherein Download Service Initiative (D)SI) and Download Info Indication (DII) messages are comprised in said modules

8. A device (8) for recording a stream of audio-visual data an application data via a digital interface (80), wherein said data is transmit inside modules through a first carousel with a first bandwidth, comprising:
(a) a processing unit (81) for calculating repetition rates of said modules in said DSMCC carousel; and
(b) a storage device (82) for recording said modules, together with said repetition rates of said modules, from said digital interface to a storage medium of said device.

9. A computer-readable medium (9) having embodied thereon a computer program for processing by a computer (90), for recording a stream of audio-visual data and application data, via a digital interface (45), wherein said data is transmit inside modules through carousel with a first bandwidth, the computer program comprising
(a) a first code segment (91) for calculating repetition rates of said modules in said carousel,
(b) a second code segment (92) for recording said modules, together with said repetition rates of said modules, from said digital interface to a storage medium of a recording device.

10. A method (6,7) of reproducing a stream of audio-visual data and application data, via a digital interface (45), wherein said application data is transmitted in modules through a first carousel (2) with a first bandwidth, comprising the steps of
(a) playing back said data inside modules through a second Carousel (4) over said digital interface (45) and from a storage medium, preferably using the complete available bandwidth of said digital interface for said carousel; and
(b) wherein said modules are played back over said digital interface at a repetition rate being stored together with said modules on said storage medium (71).

11. A method according to claim 1, wherein said digital interface (45) is a Transport Stream (TS).

12. A method according to claim 1, wherein said modules are re-inserted back into the digital interface in a re-generated order in which the modules were broadcast when said modules were recorded.

13. A method according to claim 1, wherein Download Service Initiative (DSI) and Download Info Indication (DII) messages are comprised in said modules, and wherein said repetition rates of said DSI and DII messages for playing back the DSI and DII messages is maintained at the repetition rate of the original broadcast.

14. A device (8) for reproducing a stream of audio-visual data an application data via a digital interface (80), wherein said data is transmit inside modules through a first carousel with a first bandwidth, comprising a playback device (84) for playing back said data inside modules through a second DSMCC Data/Object Carousel over said digital interface (80) and from a storage medium (83), whereby said modules are re-inserted back over said digital interface (80) at a repetition rate that is stored together with said modules on said storage medium (83).

15. A computer-readable medium (9) having embodied thereon a computer program for processing by a computer (90), for reproducing a stream of audio-visual data and application data, via a digital interface (45), wherein said data is transmit inside modules through carousel with a first bandwidth, the computer program comprising
(a) a code segment (93) for playing back said data inside modules through a Carousel over said digital interface and from a storage medium,
(b) whereby said modules are re-inserted back over a digital interface, at a repetition rate that is stored together with said modules on said storage medium.
